(19) United States
(12) Patent Application Publication
(10) Pub. No.: US 2025/0391113 A1
(43) Pub. Date: Dec. 25, 2025

(54) GENERATING PHYSICAL COMPONENTS BASED ON MACHINE LEARNING MODELS

(71) Applicant: VOLKSWAGEN AKTIENGESELLSCHAFT, WOLFSBURG (DE)

(72) Inventors: Dhanashree Balaram, Freemont, CA (US); Megan Hardy, San Francisco, CA (US)

(21) Appl. No.: 18/753,592

(22) Filed: Jun. 25, 2024

(51) Int. Cl. G06T 17/20

(52) U.S. Cl. CPC G06T 17/20

(57) ABSTRACT

A method, apparatus and system are provided to generate and/or design physical components. A complex Gaussian distribution is generated based on a set of specifications for a physical component, a set of images of the physical component, and a set of meshes for the physical component. A randomly generated point cloud is obtained. A component point cloud is generated based on the complex Gaussian distribution, the randomly generated point cloud, and a diffusion denoising model. The component point cloud represents the physical component.

### TECHNICAL FIELD

Aspects of the present disclosure relate to generating physical components, and more particularly, to generating physical components and/or designs for physical components based on machine learning models.

### BACKGROUND

Devices and/or apparatus are often composed or built from multiple physical components (e.g., parts, elements, members, etc.). The physical components are often designed, created, etc., by users (e.g., engineers) based on various specifications and/or constraints. For example, a physical component may be designed such that the physical component has a certain size, shape, geometry, etc. In another example, a physical component may be designed to fit into or interface/interact with another physical component.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram that illustrates an example system architecture, in accordance with one or more embodiments of the present disclosure.

FIG. 2 is a diagram illustrating an example component generation system, in accordance with one or more embodiments of the present disclosure.

FIG. 3 is a diagram illustrating an example component generation system that may generate a physical component, in accordance with one or more embodiments of the present disclosure.

FIG. 4 is a diagram illustrating an example component generation system that may be trained to generate a physical component, in accordance with one or more embodiments of the present disclosure.

FIG. 5 is a flow diagram of a method for generating a physical component in accordance with one or more embodiments of the present disclosure.

FIG. 6 is a flow diagram of a process for training a component generation system, in accordance with one or more embodiments of the present disclosure.

FIG. 7 is a block diagram of an example computing device that may perform one or more of the operations described herein, in accordance with some embodiments of the present disclosure.

### DETAILED DESCRIPTION

As discussed above, devices and/or apparatus are often composed or built from multiple physical components (e.g., parts, elements, members, etc.). The physical components are often designed, created, etc., by users (e.g., engineers) based on various specifications and/or constraints. Generating and/or designing new physical components may be a difficult and/or time consuming process. For example, an engineer may manually create computer aided drafting figures/drawings for a physical component. The engineer may also need to check whether the physical components meets various specifications.

The examples, implementations, and embodiments described herein may help address these issues, among others, when generating, creating, designing, etc., physical components (e.g., new physical components). In one embodiment, a component generation system generates new physical components (e.g., generates point clouds representing the physical components) based on various machine learning models (e.g., a conditional normalizing flow model, a diffusion denoising probabilistic model, etc.). The component generation system may generate the physical components based on images (e.g., hand drawn sketches), specifications, etc.

In one embodiment, the component generation system may simplify or streamline the process of generating, creating, designing, physical components. For example, rather than using a manual process for generating or creating physical components, the component generation system may apply machine learning models to generate (e.g., design) the physical components automatically. The component generation system may generate new physical components more quickly, efficiently, and with less expense than previous processes/methods.

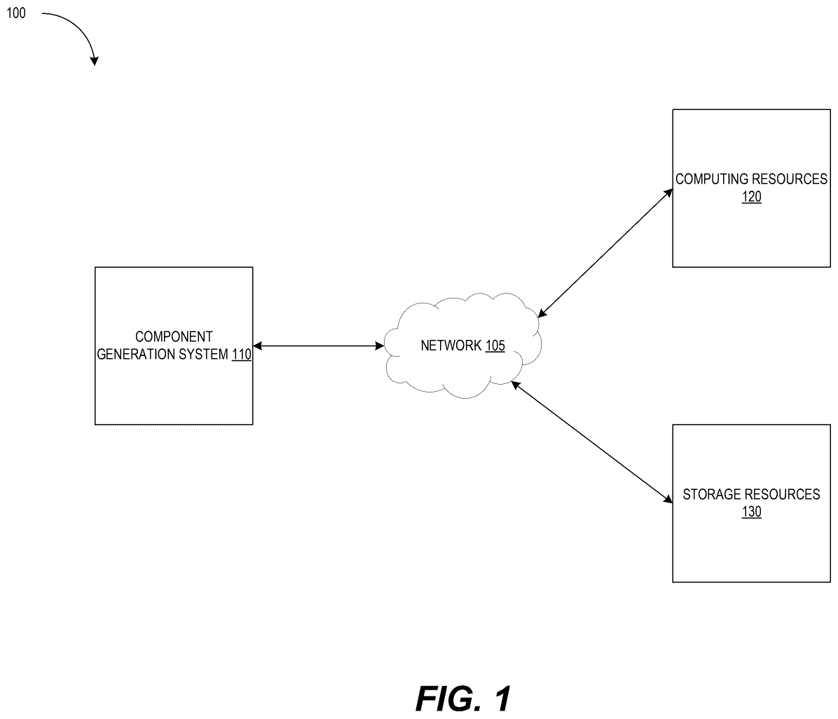

FIG. 1 is a block diagram that illustrates an example system architecture 100, in accordance with some embodiments of the present disclosure. The system architecture 100 includes network 105, a component generation system 110, computing resources 120, and storage resources 130. Network 105 may interconnect the component generation system 110, the computing resources 120, and/or the storage resources 130. Network 105 may be a public network (e.g., the internet), a private network (e.g., a local area network (LAN) or wide area network (WAN), or a combination thereof. In one embodiment, network 105 may include a wired or a wireless infrastructure, which may be provided by one or more wireless communications systems, such as a wireless fidelity (Wi-Fi) hotspot connected with the network, a cellular system, and/or a wireless carrier system that can be implemented using various data processing equipment, communication towers (e.g., cell towers), etc. Network 105 may carry communications (e.g., data, message, packets, frames, etc.) between the component generation system 110, the computing resources 120 and/or the storage resources 130.

The computing resources 120 may include computing devices which may include hardware such as processing devices (e.g., processors, central processing units (CPUs), processing cores, graphics processing units (GPUS)), memory (e.g., random access memory (RAM), storage devices (e.g., hard-disk drive (HDD), solid-state drive (SSD), etc.), and other hardware devices (e.g., sound card, video card, etc.). The computing devices may comprise any suitable type of computing device or machine that has a programmable processor including, for example, server computers, desktop computers, rackmount servers, etc. In some examples, the computing devices may include a single machine or may include multiple interconnected machines (e.g., multiple servers configured in a cluster, cloud computing resources, etc.).

The computing resources 120 may also include virtual environments. In one embodiment, a virtual environment may be a virtual machine (VM) that may execute on a hypervisor which executes on top of the OS for a computing device. The hypervisor may also be referred to as a virtual machine monitor (VMM). A VM may be a software implementation of a machine (e.g., a software implementation of a computing device) that includes its own operating system (referred to as a guest OS) and executes application programs, applications, software. The hypervisor may be a component of an OS for a computing device, may run on top of the OS for a computing device, or may run directly on host hardware without the use of an OS. The hypervisor may manage system resources, including access to hardware devices such as physical processing devices (e.g., processors, CPUs, etc.), physical memory (e.g., RAM), storage device (e.g., HDDs, SSDs), and/or other devices (e.g., sound cards, video cards, etc.). The hypervisor may also emulate the hardware (or other physical resources) which may be used by the VMs to execute software/applications. The hypervisor may present other software (i.e., “guest” software) the abstraction of one or more virtual machines (VMs) that provide the same or different abstractions to various guest software (e.g., guest operating system, guest applications). A VM may execute guest software that uses an underlying emulation of the physical resources (e.g., virtual processors and guest memory).

In another embodiment, a virtual environment may be a container that may execute on a container engine which executes on top of the OS for a computing device, as discussed in more detail below. A container may be an isolated set of resources allocated to executing an application, software, and/or process independent from other applications, software, and/or processes. The host OS (e.g., an OS of the computing device) may use namespaces to isolate the resources of the containers from each other. A container may also be a virtualized object similar to virtual machines. However, a container may not implement separate guest OS (like a VM). The container may share the kernel, libraries, and binaries of the host OS with other containers that are executing on the computing device. The container engine may allow different containers to share the host OS (e.g., the OS kernel, binaries, libraries, etc.) of a computing device. The container engine may also facilitate interactions between the container and the resources of the computing device. The container engine may also be used to create, remove, and manage containers.

The storage resources 130 may include various different types of storage devices, such as hard disk drives (HDDs), solid state drives (SSD), hybrid drives, storage area networks, storage arrays, etc. The storage resources 130 may also include cloud storage resources or platforms which allow for dynamic scaling of storage space.

Although the computing resources 120 and the storage resources 130 are illustrated separate from the component generation system 110, one or more of the computing resources 120 and the storage resources 130 may be part of the component generation system 110 in other embodiments. For example, the component generation system 110 may include both the computing resources 120 and the storage resources 130.

As discussed above, designing, creating, generating, etc., new physical components (e.g., a door frame, a window, a hinge, a joint, etc.) to be used in a larger device/apparatus (e.g., a vehicle, an electronic device, etc.) is often a manual process that is performed by users, such as design engineers, mechanical engineers, etc. For example, an engineer may obtain the specifications and manual design, draw, etc., a new physical component that satisfies the various specifications. The engineer may need to manually verify that the physical component satisfies the various specifications. The engineer may also need to confirm that the physical component is able to fit within and/or interface/connect with other physical components.

In one embodiment, the component generation system 110 may allow for the generation of new or novel physical components that conform to various specifications, conditions, parameters, and/or images provided by a user. The component generation system 110 may automatically generate and/or create physical components and/or designs for physical components that specifications, conditions, parameters, etc., provided by a user. Portions of the physical component may be based on and/or may match the images/sketches provided by the user. These physical components may be able to interface with other physical components (e.g., fit into and/or connect to other physical components). The component generation system 110 may allow for a more streamlined, more automatic (e.g., partially or fully automated), faster, and/or more efficient generation, creation, design, etc., of new physical components. This may allow new components to be designed, created, etc., more quickly and efficiently.

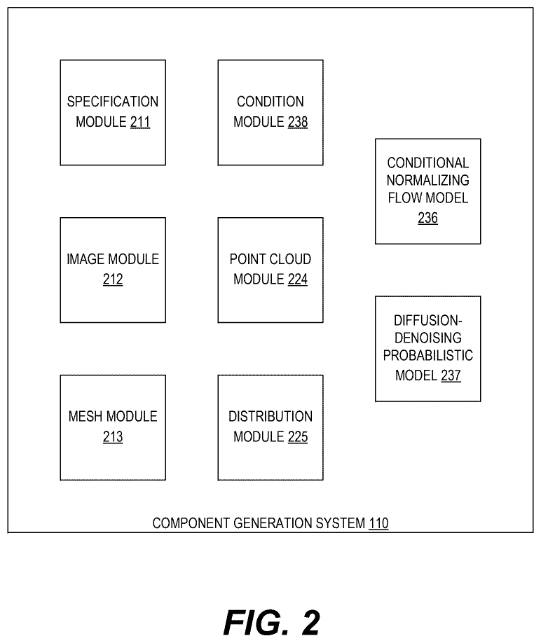

FIG. 2 is a diagram illustrating an example component generation system 110, in accordance with one or more embodiments of the present disclosure. The component generation system 110 may include a specification module 211, an image module 212, a mesh module 213, a point cloud module 224, a distribution module 225, a conditional normalizing flow model (CNFM) 236, a condition module 238, and a diffusion denoising probabilistic model (DDPM) 237. Each of the specification module 211, the image module 212, the mesh module 213, the point cloud module 224, the distribution module 225, the CNFM 236, and the DDPM 237 may be a combination of hardware, software, and firmware. In addition, any of the specification module 211, the image module 212, the mesh module 213, the point cloud module 224, the distribution module 225, the CNFM 236, the condition module 238, and the DDPM 237 may be combined together, divided into other modules, and/or distributed over multiple computing devices. Furthermore, any of the specification module 211, the image module 212, the mesh module 213, the point cloud module 224, the distribution module 225, the CNFM 236, the condition module 238, and the DDPM 237 may be located in cloud computing platforms and/or cloud storage platforms.

As discussed above, the component generation system 110 may generate, create, design, etc., components that may be used in various apparatuses or devices. A physical component may be any object that may be included in another device/apparatus, may interface and/or connect with other objects, etc. For example, the component generation system 110 may generate a new physical component that will be included in a vehicle (e.g., may create a window that may be installed included in the vehicle when the vehicle is manufactured).

In one embodiment, the specification module 211 may obtain, receive, etc., a set of specifications (e.g., one or more specifications) for the physical component. For example, the specification module 211 may access one or more files that include the set of specifications. In another example, the specification module 211 may provide a user interface (e.g., a graphical user interface (GUI), a command line interface (CLI), etc.) and may receive user input indicating the set of specifications. The set of specifications may be provided in an open format and/or a specific format/syntax. For example, a text file with a written (e.g., natural language) description of the specifications may be used. In another example, a table or list with specific fields and/or values may be used.

In one embodiment, the set of specifications may indicate one or more physical properties for a physical component. A physical property may indicate a shape/geometry for at least a portion of the physical component. For example, the set of specifications may indicate geometric properties for a physical component, such as a desired thickness, desired width, a desired height, a desired curvature, etc., for the physical component. In another example, the set of specifications may indicate that the physical component should have a certain number of holes/vias at certain locations, one or more hollow portions at certain locations, one or more flat surfaces, etc. The set of specifications may also indicate different physical properties for different portions of a physical component (e.g., a flat surface on the top of a physical component but a curved surface on the bottom of the physical component).

In one embodiment, the specification module 211 may encode the set of specifications for the physical component. For example, the specification module 211 may generate a vector that represents the set of specifications for the physical component. The specification module 211 may include a machine learning model (e.g., a convolutional neural network, a recurrent neural network, a large language model, or some other appropriate model) that processes the set of specifications (e.g., receives the set of specifications as an input) and generates an encoding and/or other representation of the set of specifications. For example, the specification module 211 may generate a vector that indicates/represents the set of specifications. The vector that indicates/represents the set of specifications may be referred to as a specification vector.

In one embodiment, the image module 212 may obtain a set of images (e.g., one or more images) for the physical component. For example, the specification module 211 may access or retrieve the one or more images from a storage location (e.g., a memory, a database, a cloud storage platform, etc.). In another example, the specification module 211 may provide a user interface (e.g., a graphical user interface (GUI), a command line interface (CLI), etc.) that allows the user to upload and/or provide the set of images.

In one embodiment, the set of images may be associated with and/or may depict, show, illustrate, show, etc., at least portions of the physical component. For example, the set of images may be sketches (e.g., hand drawn sketches, computer-aided drafting images, etc.) of the physical component from different angles or perspective (e.g., a top down view, an isometric view, etc.). The set of images may be 2-dimensional (2D) images of the physical component. The set of images may also illustrate, show, depict, etc., some portions of the physical component. For example, the set of images may depict only a right side/half of the physical component. The set of images may include color, grayscale, and/or black and white images. The colors, grayscale, etc., within the set of images may indicate different properties of the physical component. For example, a first color may indicate a depression in the physical component and a second color may indicate a protrusion in the physical component. In one embodiment, at least a portion of the physical component generated by the component generation system 110 may match a portion of images.

In one embodiment, the image module 212 may encode the set of images. For example, the image module 212 may generate a vector that represents the set of images. The specification module 211 may include a machine learning model (e.g., a convolutional neural network, a recurrent neural network, a large language model, or some other appropriate model) that processes the set of images (e.g., receives the set of images as an input) and generates an encoding and/or other representation of the set of images. For example, the specification module 211 may generate a vector that indicates/represents the set of images. The vector that indicates/represents the set of images may be referred to as an image vector.

In one embodiment, the mesh module 213 may obtain, receive, etc., a set of meshes (e.g., one or more meshes) for or associated with the physical component. For example, the mesh module 213 may access one or more files that include the set of meshes. In another example, the mesh module 213 1 may provide a user interface (e.g., a graphical user interface (GUI), a command line interface (CLI), etc.) and may receive user input indicating the set of meshes.

In one embodiment, the set of meshes may indicate one or more physical properties of another component that may interact, interface with, come into contact with, connect to, etc., the physical component (or portions of the physical component). For example, the set of meshes may indicate the shape, dimensions, etc., of another component that may be connected to or coupled to the left side of the physical component. In another example, the set of meshes may indicate the shape, dimensions, etc., of another component that surrounds the physical component (e.g., the physical component may be window and the other component may be a door of a vehicle where the window is located).

In one embodiment, the mesh module 213 may encode the set of meshes. For example, the mesh module 213 may generate a vector that represents the set of meshes. The mesh module 213 may include a machine learning model (e.g., a convolutional neural network, a recurrent neural network, a large language model, or some other appropriate model) that processes the set of meshes (e.g., receives the set of meshes as an input) and generates an encoding and/or other representation of the set of meshes. For example, the mesh module 213 may generate a vector that indicates/represents the set of meshes. The vector that indicates/represents the set of meshes may be referred to as a mesh vector.

In one embodiment, the condition module 238 may generate a combined encoding and/or representation for the set of specifications, set of images, and/or set of meshes. The condition module 238 may generate a combined vector that is a combination of the vector for the set of specifications, vector for the set of images, and/or vector for the set of meshes. For example, the condition module 238 may concatenate the vector for the set of specifications, vector for the set of images, and/or vector for the set of meshes. In another example, the condition module 238 may add or multiply the vector for the set of specifications, vector for the set of images, and/or vector for the set of meshes together.

In one embodiment, the point cloud module 224 may generate one or more point clouds that may be used to generate, create, design, etc., physical components. A point cloud may be set of data points in space (e.g., one or more points Cartesian space). Each point in the point cloud may have or may be associated with a set of Cartesian coordinates (X, Y, Z). A point cloud that includes points in Cartesian space may be referred to as a 3-dimensional (3D point cloud). A point cloud may include any number of points (e.g., tens, hundreds, thousands, millions, etc., of points). The point cloud module 224 may generate a random point cloud (e.g., may generate a point cloud by randomly selecting points to include in the point cloud). The point cloud that is generated by the point cloud module 224 may be provided to the DDPM 237 and the DDPM 237 may generate an output or component point cloud that represents a physical component, as discussed in more detail below.

In one embodiment, the distribution module 225 may generate one or more distributions. For example, the distribution module 225 may generate one or more Gaussian distributions. A Gaussian distribution may also be referred to as a normal distribution, a simple Gaussian distribution, etc. The distribution module 255 may randomly generate (or identify, select, etc.) the one or more distributions. For example, the distribution module 255 may randomly select a mean for the Gaussian distribution. In another example, the distribution module 255 may randomly select the variance for the Gaussian distribution. In a further example, the distribution module 255 may randomly select the mean for the Gaussian distribution but may use a variance of 1 (e.g., may select a random standard normal/Gaussian distribution). The Gaussian distribution may be provided to and/or used by the CNFM 236, as discussed in more detail below.

In one embodiment, the CNFM 236 may perform a normalizing flow (e.g., may perform normalizing flow functions) on one or more distributions. A normalizing flow or normalizing flow functions may generate (e.g., create, determine, calculate, transform, map, etc.) an output distribution based on an input distribution. The normalizing flow may use, apply, map, etc., a series of invertible functions to the input distribution to generate, calculate, determine, calculate, etc., the output distribution. The CNFM 236 may receive input distributions, apply one or more invertible functions to the input distributions (e.g., perform normalizing flow functions, transform the input distribution), and generate the output distribution. For example, a normalizing flow may transform a complex Gaussian distribution (e.g., an input distribution) into a simple/normal Gaussian distribution (e.g., an output distribution), as discussed in more detail below. In another example, a normalizing flow may transform a simple/normal distribution (e.g., an input distribution) into a complex Gaussian distribution (e.g., an output distribution), as discussed in more detail below. This may be referred to as a reverse normalizing flow or a generative normalizing flow.

In one embodiment, the CNFM 236 may transform the input distribution into an output distribution based on one or more conditions, parameters, requirements, etc. For example, the condition module 238 may generate a combined vector, as discussed above. The combined vector may be an encoding and/or representation of various conditions, parameters, requirements, constraints, etc., on the shape, design, features, and/or other physical/geometric properties of the physical component. The CNFM 236 may generate a distribution (e.g., a complex distribution) based on the combined vector, as discussed in more detail below.

In one embodiment, the DDPM 237 may be a type of generative model (e.g., a machine learning model, a generative machine learning model, etc.) that may be trained by iteratively and/or gradually/iteratively applying noise to an input (e.g., diffusion) and then learning how to gradually/iteratively remove noise that was added (e.g., denoising or reverse diffusion).

In one embodiment, the DDPM 237 may generate a point cloud that represents the physical component, based on an input point cloud (e.g., a random point cloud) and the distribution (e.g., the complex distribution) generated by the CNFM 236. The distribution generated by the CNFM 236 may provide guidance (e.g., instructions, directions, etc.) to the DDPM 237 as the DDPM 237 removes points from the input point cloud and/or moves points in the input point cloud to generate the point cloud that represents the physical component, as discussed in more detail below. The physical component represented by the point cloud generated by the DDPM 237 may be a new physical component (e.g., a new design for a physical component).

As discussed above, designing, creating, generating, etc., new physical components (e.g., a door frame, a window, a hinge, a joint, etc.) to be used in a larger device/apparatus (e.g., a vehicle, an electronic device, etc.) is often a manual process that is performed by users, such as design engineers, mechanical engineers. The component generation system 110 may allow for the generation of new or novel physical components that conform to various specifications, conditions, parameters, and/or images provided by a user. The component generation system 110 may also streamline and/or automate this processed, allowing for faster and/or more efficient creation, generation, and/or design of new physical components.

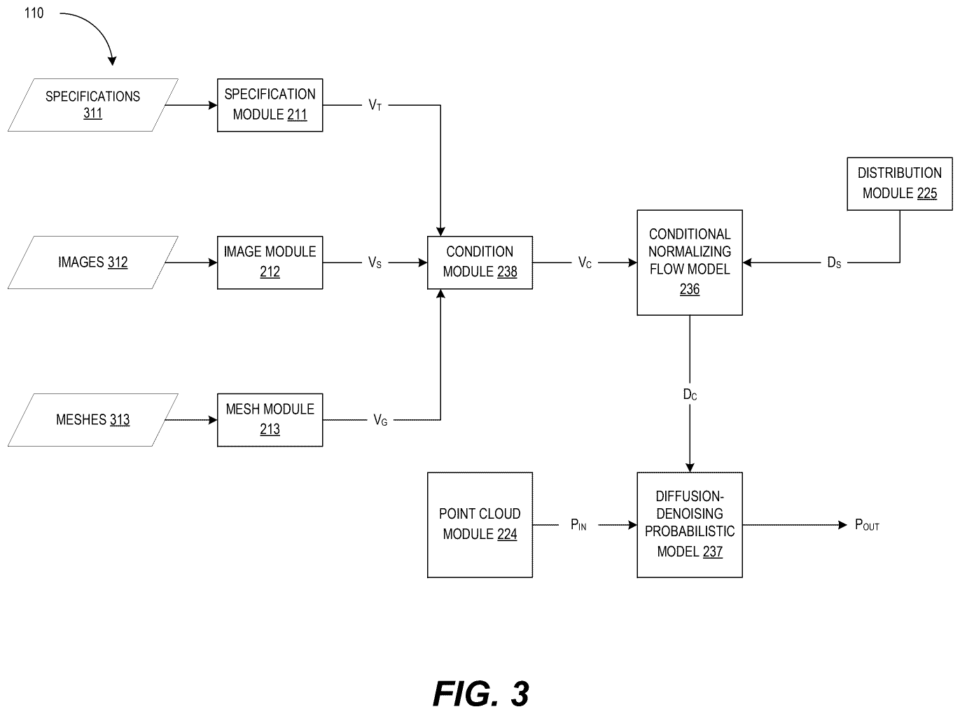

FIG. 3 is a diagram illustrating an example component generation system 110 that may generate a physical component, in accordance with one or more embodiments of the present disclosure. The component generation system 110 includes specification module 211, image module 212, mesh module 213, condition module 238, point cloud module, distribution module 225, 224, CNFM 236, and DDPM 237.

As discussed above, the specification module 211 may receive specifications and may encode the specifications 311 into a vector V_{T}. The image module 212 may receive images 312 and may encode the specifications into a vector V_{S}. The mesh module 213 may receive meshes 313 and may encode the meshes into a vector V_{G}. The vectors V_{T}, V_{S}, and V_{G} may be provided to the condition module 238 which may generate a combined vector V_{C}.

In one embodiment, the component generation system 110 may generate a distribution D_{C} (e.g., a complex Gaussian distribution) based on the specifications 311, images 312, and the meshes 313. For example, the CNFM 236 may receive or obtain the combined vector V_{C} and may also receive a distribution D_{S} from the distribution module 225. As discussed above, the distribution D_{S} may be a random simple Gaussian distribution (e.g., a randomly generated simple Gaussian distribution or randomly generated normal distribution). The CNFM 236 may generate a complex Gaussian distribution based on the combined vector V_{C} and the simple Gaussian distribution D_{S}. For example, the CNFM 236 may generate the distribution D_{C} (e.g., the complex Gaussian distribution) by performing a series of invertible transformations on the distribution D_{S}.

In one embodiment, the series of invertible transformations that are performed on the distribution D_{S} may be based on the conditions that are encoded into the combined vector V_{C}. For example, the variables, coefficients, inputs, parameters, etc., of the transformations (e.g., mappings, functions, etc.) may use and/or may be based on one or more of the conditions encoded in the combined vector V_{C}. This may allow the transformations to be based or conditioned on the specifications 311, the images 312, and/or the meshes 313. For example, the transformations may be based on the conditions that are encoded in or represented by the combined vector V_{C}.

When the CNFM 236 generates the distribution D_{C} (e.g., the complex Gaussian distribution) from the distribution D_{S} (e.g., the simple Gaussian distribution) based on the combined vector V_{C} (e.g., one or more conditions or encodings/representations of one or more conditions), this may be referred to as a reverse conditional normalizing flow. For example, the normalizing flow is reversed because the normalizing flow is generating a complex Gaussian distribution based on a simple Gaussian distribution. In another example, the normalizing flow is conditional because the normalizing flow (e.g., the reverse normalizing flow) is performed based on the one or more conditions or encodings/representations of one or more conditions in the combined vector V_{C}. In one embodiment, the distribution D_{C} may provide guidance, direction, instructions, etc., to the DDPM 237, when generating a point cloud. For example, the distribution D_{C} may indicate which point should be removed and/or should be included in the generated point cloud, as discussed in more detail below.

In one embodiment, the DDPM 237 may receive or obtain a point cloud PIN from the point cloud module 224. As discussed above, the point cloud PIN may be a randomly generated point cloud (e.g., maybe a point cloud where the points in the point cloud are randomly selected/generated). The DDPM 237 may also receive or obtain the distribution D_{C} (e.g., the complex Gaussian distribution) generated by the CNFM 236 (e.g., generated using a conditional reverser normalizing flow). The DDPM 237 may generate an output point cloud P_{OUT} based on the distribution D_{C} and the point cloud P_{IN}. For point cloud P_{OUT} may represent the physical component. For example, the point cloud P_{OUT} may indicate the structure, shape, and/or other physical/geometric features of the physical component. The point cloud P_{OUT} may also be referred to as a component point cloud (e.g., because the point cloud P_{OUT} represents the physical component).

In one embodiment, the DDPM 237 may generate the point cloud P_{OUT} by moving (e.g., arranging, rearranging, etc.) one or more points (e.g., changing the position and/or coordinates of one or more points) in the point cloud P_{IN}. For example, the DDPM 237 may perform multiple iterations (e.g., multiple cycles, rounds, etc.) and in each iteration, one or more points in the point cloud P_{IN} may be moved to a different location. At the end of the iterations, the point cloud that includes the re-arranged or moved points may form the point cloud P_{OUT}. In another embodiment, the DDPM 237 may generate the point cloud P_{OUT} by removing a set of points (e.g., one or more points) from the P_{IN}. For example, the DDPM 237 may perform multiple iterations (e.g., multiple cycles, rounds, etc.) and in each iteration, one or more points may be removed from the point cloud P_{IN}. At the end of the iterations, the remaining points in the point cloud may form the point cloud P_{OUT}.

In one embodiment, the DDPM 237 may remove and/or move one or more points in each iteration based on and/or using the distribution D_{C} (e.g., the complex Gaussian distribution generated by CNFM 236 using a conditional reverse normalizing flow). As discussed above, the distribution D_{C} may provide guidance (e.g., instructions, directions, etc.) to the DDPM 237 when the DDPM 237 removes points from the point cloud P_{IN} and/or moves points in each iteration. For example, the distribution D_{C} may indicate which points in the point cloud P_{IN} are removable/movable (e.g., which points are allowed to be removed/moved) during each iteration. In another example, the distribution D_{C} may allow the DDPM 237 to calculate, determine, identify, etc., which points in the point cloud P_{IN} are removable/movable during each iteration. In one example, the distribution D_{C} may indicate which points in the point cloud P_{IN} are not removable/movable (e.g., which points should not be removed/moved) during each iteration. In a further example, the distribution D_{C} may allow the DDPM 237 to calculate, determine, identify, etc., which points in the point cloud P_{IN} are not removable/movable during each iteration.

In one embodiment, the point cloud P_{OUT} may represent a physical component that has been designed, created, generated, etc., by the component generation system 110. For example, the point cloud P_{OUT} may show the shape and/or structure of the physical component (e.g., the three-dimensional (3D) shape and/or structure). The point cloud P_{OUT} may represent surfaces, holes, protrusions, gaps, cavities, and/or other physical features of the physical component.

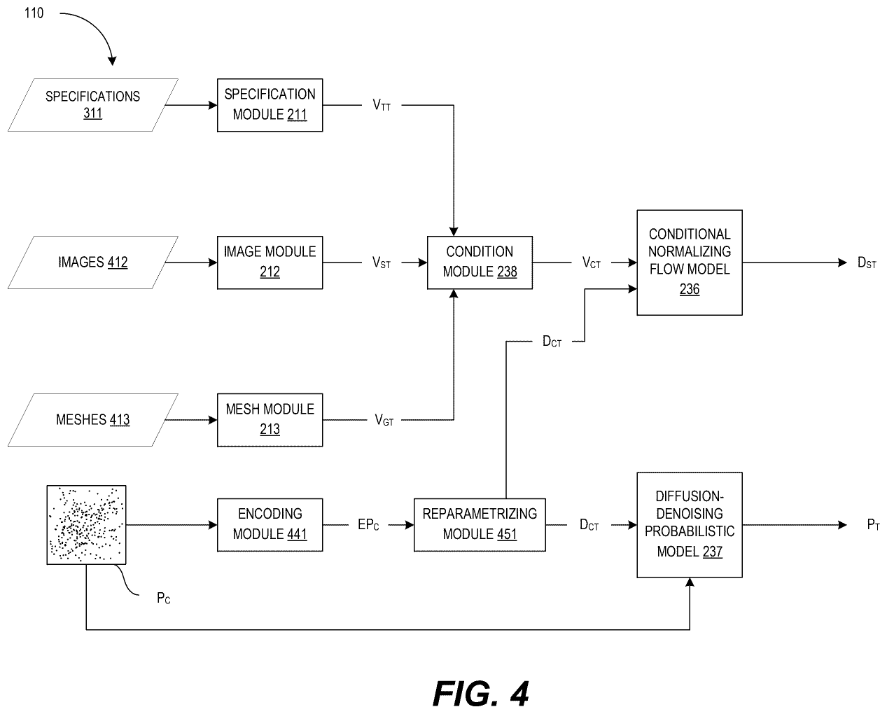

FIG. 4 is a diagram illustrating an example component generation system 110 that may be trained to generate a physical component, in accordance with one or more embodiments of the present disclosure. The component generation system 110 includes specification module 211, image module 212, mesh module 213, condition module 238, point cloud module, distribution module 225, 224, CNFM 236, and DDPM 237. As discussed above, the specification module 211 may receive specifications and may encode the specifications 411 into a vector V_{TT}. The image module 212 may receive images 412 and may encode the specifications into a vector V_{ST}. The mesh module 213 may receive meshes 413 and may encode the meshes into a vector V_{GT}. The vectors V_{TT}, V_{ST}, and V_{GT} may be provided to the condition module 238 which may generate a combined vector V_{CT}.

In one embodiment, the encoding module 441 may receive a point cloud P_{C} that represents a physical component (or multiple physical components) to be used when training component generation system (e.g., when training the CNFM 236 and/or the DDPM 237). The encoding module 441 may analyze the point cloud P_{C} to determine the mu (e.g., mean) and sigma (e.g., standard deviation) of the point cloud P_{C}. The mu and the sigma of the point cloud P_{C} is represented as EP_{C}. EP_{C} (e.g., the mu and the sigma of the point cloud P_{C}) is provided to the reparametrizing module 451.

In one embodiment, the reparametrizing module 451 may generate a distribution D_{CT} based on EP_{C}. For example, the reparametrizing module 451 may perform a reparametrizing trick (e.g., may perform operations for a reparametrizing trick) using EP_{C} as an input, to generate the distribution D_{CT}. The distribution D_{CT} may be a complex Gaussian distribution (e.g., a complex distribution) that is associated and/or represents the point cloud P_{C}.

The specifications 411, the images 412, and the meshes 413, point cloud P_{C}, vectors V_{TT}, V_{ST}, V_{GT}, V_{CT}, distribution D_{CT}, and E_{PC} may be part of a set of training data that is used to train the CNFM 236 and/or the DDPM 237.

In one embodiment, during the training process for the component generation system 110 (e.g., during the training process for the CNFM 236 and/or the DDPM 237), the combined vector V_{CT} and the distribution D_{CT} may be provided to the CNFM 236. The CNFM 236 may be trained using the combined vector V_{CT} and the distribution D_{CT}. The CNFM 236 may be trained to map the distribution D_{CT} (e.g., a complex Gaussian distribution) to a distribution D_{ST} (e.g., a simple Gaussian distribution) based on the combined vector V_{CT} and the distribution D_{CT}. For example, the CNFM 236 may be trained to by adjusting one or more parameters of one or more loss functions of the CNFM 236 (e.g., optimizing one or more loss functions) based on the combined vector V_{CT} (e.g., specifications, images, meshes, etc., represented or encoded in the combined vector V_{CT}).

In one embodiment, during the training process for the component generation system 110 (e.g., during the training process for the CNFM 236 and/or the DDPM 237), the DDPM 237 may generate a point cloud PT. The point cloud P_{T} may represent the physical component described, presented, illustrated, etc., in the representations 424. Given the point cloud P_{C} and the distribution D_{CT} (e.g., a complex Gaussian distribution), the DDPM 237 may perform a forward diffusion process that adds Gaussian noise to the point cloud P_{C} based on sampled time steps from a uniform time schedule with different values of variance, to generate a point cloud P_{N}. A reverse diffusion process is performed to train the DDPM 237 to remove the noise from the point cloud P_{C} to generate point cloud Pr. The component generation system 110 may check whether the point cloud P_{T} is the same (or has a threshold number of similar points) as point cloud P_{C}.

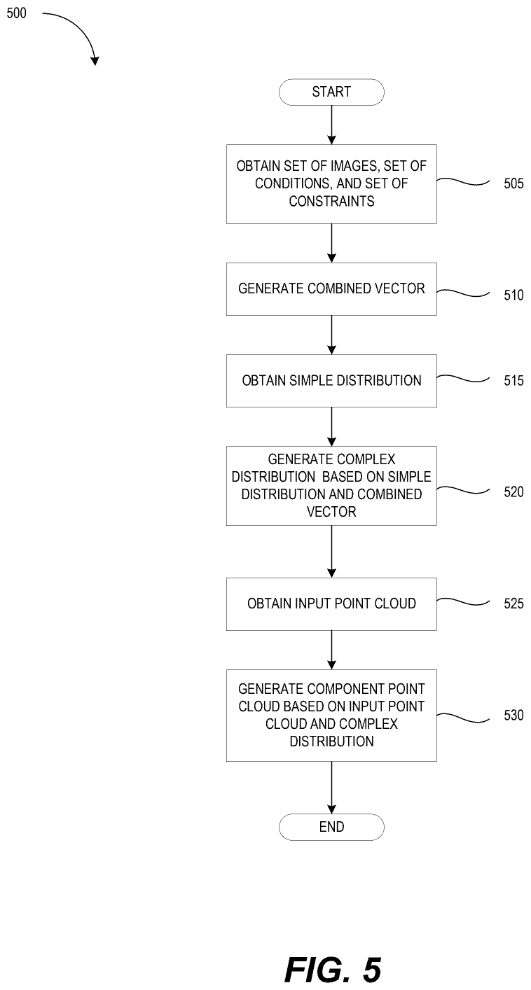

FIG. 5 is a flow diagram of a method 500 for generating a physical component in accordance with one or more embodiments of the present disclosure. Method 500 may be performed by processing logic that may comprise hardware (e.g., circuitry, dedicated logic, programmable logic, a field programmable gate array (FPGA), an application specific integrated circuit (ASIC), a processor, a processing device, a central processing unit (CPU), a system-on-chip (SoC), etc.), software (e.g., instructions running/executing on a processing device), firmware (e.g., microcode), or a combination thereof. In some embodiments, the method 500 may be performed by one or more computing devices or computing systems (e.g., one or more of the component generation system 110, the specification module 211, the image module 212, the mesh module 213, the condition module 238, the point cloud module 224, the distribution module 225, the CNFM 236, the DDPM 237, etc., illustrated in FIGS. 1-4).

With reference to FIG. 5, method 500 illustrates example functions used by various embodiments. Although specific function blocks (“blocks”) are disclosed in method 500, such blocks are examples. That is, embodiments are well suited to performing various other blocks or variations of the blocks recited in method 500. It is appreciated that the blocks in method 500 may be performed in an order different than presented, and that not all of the blocks in method 500 may be performed, and other blocks (which may not be included in FIG. 5) may be performed between the blocks illustrated in FIG. 5.

Method 500 begins at block 505 where the method 500 obtains a set of images, a set of specifications, and a set of meshes. As discussed above, the images may be sketches and/or drawings of a physical component that a user may want to create, the specification may indicate physical/geometrical properties of the physical component, and the meshes may indicate/represent other components that may interact with the physical component. The set of images, set of specifications, and/or set of meshes may be constraints, conditions, parameters, etc. for generating the physical component. At block 510, the method 500 may generate a combined vector that may encode, represent, indicate the set of images, the set of specifications, and the set of meshes.

At block 515 the method 500 may obtain a simple distribution. For example, a random Gaussian distribution may be generated. At block 520, the method 500 generates a complex distribution based on the simple distribution and the combined vector. For example, a reverse conditional normalizing flow may be performed on the simple distribution using the combined vector. As discussed above, the complex distribution may provide guidance on how to create and/or generate the physical component.

At block 525, the method 500 obtains an input point cloud. For example, a point cloud may be randomly generated (e.g., the points in the point cloud may be randomly selected). The method 500 generates a component point cloud (e.g., an output point cloud) based on the input point cloud and the complex distribution. For example, the method 500 may use a DDPM to iteratively remove points (e.g., noise) from the point cloud and/or move points to generate the component point cloud.

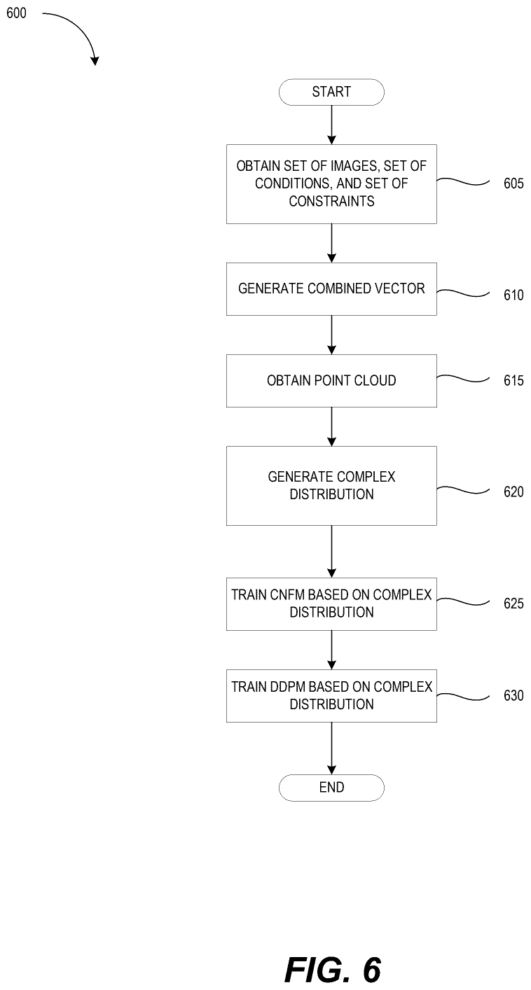

FIG. 6 is a flow diagram of a process for training a component generation system, in accordance with one or more embodiments of the present disclosure. Method 600 may be performed by processing logic that may comprise hardware (e.g., circuitry, dedicated logic, programmable logic, a field programmable gate array (FPGA), an application specific integrated circuit (ASIC), a processor, a processing device, a central processing unit (CPU), a system-on-chip (SoC), etc.), software (e.g., instructions running/executing on a processing device), firmware (e.g., microcode), or a combination thereof. In some embodiments, the method 600 may be performed by one or more computing devices or computing systems (e.g., one or more of the component generation system 110, the specification module 211, the image module 212, the mesh module 213, the condition module 238, the point cloud module 224, the distribution module 225, the CNFM 236, the DDPM 237, etc., illustrated in FIGS. 1-4).

With reference to FIG. 6, method 600 illustrates example functions used by various embodiments. Although specific function blocks (“blocks”) are disclosed in method 600, such blocks are examples. That is, embodiments are well suited to performing various other blocks or variations of the blocks recited in method 600. It is appreciated that the blocks in method 600 may be performed in an order different than presented, and that not all of the blocks in method 600 may be performed, and other blocks (which may not be included in FIG. 6) may be performed between the blocks illustrated in FIG. 6.

Method 600 begins at block 605 where the method 600 obtains a set of images, a set of specifications, and a set of meshes. As discussed above, the images may be sketches and/or drawings of a physical component that a user may want to create, the specifications may indicate physical/geometrical properties of the physical component, and the meshes may indicate/represent other components that may interact with the physical component. The set of images, set of specifications, and/or set of meshes may be constraints, conditions, parameters, etc. for generating the physical component. At block 610, the method 600 may generate a combined vector that may encode, represent, indicate the set of images, the set of specifications, and the set of meshes.

At block 615, the method 600 may obtain a point cloud (e.g., an input point cloud). The point cloud may be a point cloud that represents a physical component. At block 620, the method 600 may generate a complex distribution. For example, the method 600 may obtain the sigma and mu of the point cloud and may generate a complex distribution based on the sigma and mu of the point cloud.

At block 625, a CNFM of the component generation system may be trained based on the complex distribution. For example, the CNFM may be trained to transform the complex distribution to a simple distribution, based on the combined vector. At block 630, a DDPM of the component generation system is trained. For example, the DDPM may be trained to generate an output point cloud that matches or has a threshold number of points that match the input point cloud, based on the complex distribution.

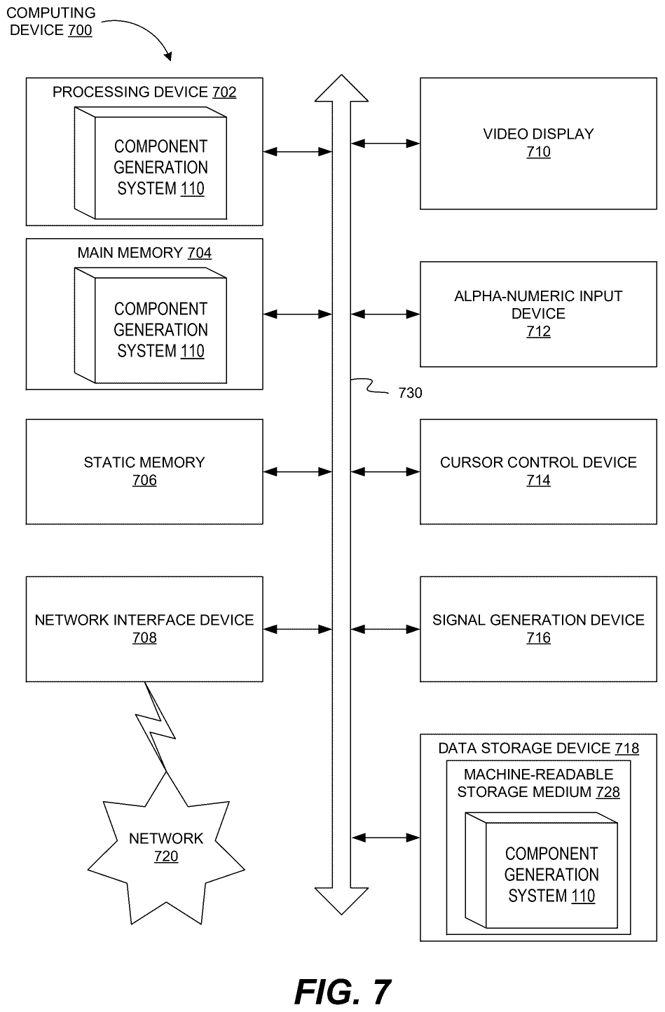

FIG. 7 is a block diagram of an example computing device 700 that may perform one or more of the operations described herein, in accordance with some embodiments. Computing device 700 may be connected to other computing devices in a LAN, an intranet, an extranet, and/or the Internet. The computing device may operate in the capacity of a server machine in client-server network environment or in the capacity of a client in a peer-to-peer network environment. The computing device may be provided by a personal computer (P_{C}), a set-top box (STB), a server, a network router, switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

The example computing device 700 may include a processing device (e.g., a general purpose processor, a PLD, etc.) 702, a main memory 704 (e.g., synchronous dynamic random access memory (DRAM), read-only memory (ROM)), a static memory 706 (e.g., flash memory and a data storage device 718), which may communicate with each other via a bus 730.

Processing device 702 may be provided by one or more general-purpose processing devices such as a microprocessor, central processing unit, or the like. In an illustrative example, processing device 702 may comprise a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 702 may also comprise one or more special-purpose processing devices such as an application specific integrated circuit (ASIC), a field programmable gate array (FPGA), a digital signal processor (DSP), network processor, or the like. The processing device 702 may be configured to execute the operations described herein, in accordance with one or more aspects of the present disclosure, for performing the operations and steps discussed herein.

Computing device 700 may further include a network interface device 708 which may communicate with a network 720. The computing device 700 also may include a video display unit 710 (e.g., a liquid crystal display (LCD) or a cathode ray tube (CRT)), an alphanumeric input device 712 (e.g., a keyboard), a cursor control device 714 (e.g., a mouse) and an acoustic signal generation device 716 (e.g., a speaker). In one embodiment, video display unit 710, alphanumeric input device 712, and cursor control device 714 may be combined into a single component or device (e.g., an LCD touch screen).

Data storage device 718 may include a computer-readable storage medium 728 on which may be stored one or more sets of instructions, e.g., instructions for carrying out the operations described herein, in accordance with one or more aspects of the present disclosure. Instructions implementing the different systems described herein (e.g., the component generation system 110, the specification module 211, the image module 212, the mesh module 213, the condition module 238, the point cloud module 224, the distribution module 225, the CNFM 236, the DDPM 237, etc., illustrated in FIGS. 1-4) may also reside, completely or at least partially, within main memory 704 and/or within processing device 702 during execution thereof by computing device 700, main memory 704 and processing device 702 also constituting computer-readable media. The instructions may further be transmitted or received over a network 720 via network interface device 708.

While computer-readable storage medium 728 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media and magnetic media.

Additional non-limiting examples, implementations, embodiments, etc., are described in APPENDIX A, which is hereby incorporated by reference in its entirety.

Unless specifically stated otherwise, terms such as “obtaining,” “determining,” “generating,” “calculating,” “performing,” “obtaining,” “updating,” “training,” “transforming,” “mapping,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

When an action, function, operation, etc., is described herein as being performed automatically, this may indicate that the action, function, operation, etc., may be performed without requiring human or user input, invocation, or interaction.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component.

Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A method, comprising:
generating a complex Gaussian distribution based on a set of specifications for a physical component, a set of images of the physical component, and a set of meshes for the physical component;
obtaining a randomly generated point cloud; and
generating a component point cloud based on the complex Gaussian distribution, the randomly generated point cloud, and a diffusion denoising model, wherein the component point cloud represents the physical component.

2. The method of claim 1, wherein obtaining the complex Gaussian distribution comprises:
generating a first vector based on the set of specifications;
generating a second vector based on the set of images;
generating a third vector based on the set of meshes; and
generating a combined vector based on the first vector, the second vector, and the third vector.

3. The method of claim 2, wherein obtaining the complex Gaussian distribution further comprises:
generating the complex Gaussian distribution based on the combined vector, a simple Gaussian distribution, and a reverse conditional normalizing flow model.

4. The method of claim 3, wherein the reverse conditional normalizing flow model transforms the simple Gaussian distribution to the complex Gaussian distribution based on the combined vector.

5. The method of claim 3, wherein the combined vector indicates one or more conditions for transforming the simple Gaussian distribution to the complex Gaussian distribution.

6. The method of claim 3, wherein the simple Gaussian distribution is randomly generated.

7. The method of claim 3, wherein generating the component point cloud comprises:
moving a set of points from the randomly generated point cloud based on the complex Gaussian distribution, wherein the complex Gaussian distribution indicates one or more points that can be moved.

8. The method of claim 1, wherein the set of specifications indicate one or more physical properties of the physical component.

9. The method of claim 1, wherein the set of images comprise one or more of 2-dimensional images and color images.

10. The method of claim 1, wherein the set of meshes indicate physical properties of one or more other components that may interact with the physical component.

11. An apparatus, comprising:
a memory configured to store data; and
a processing device communicatively coupled to the memory, the processing device configured to:
generate a complex Gaussian distribution based on a set of specifications for a physical component, a set of images of the physical component, and a set of meshes for the physical component;
obtain a randomly generated point cloud; and
generate a component point cloud based on the complex Gaussian distribution, the randomly generated point cloud, and a diffusion denoising model, wherein the component point cloud represents the physical component.

12. The apparatus of claim 11, wherein to obtain the complex Gaussian distribution the processing device is further configured to:
generate a first vector based on the set of specifications;
generate a second vector based on the set of images;
generate a third vector based on the set of meshes; and
generate a combined vector based on the first vector, the second vector, and the third vector.

13. The apparatus of claim 12, wherein to obtain the complex Gaussian distribution further the processing device is further configured to:
generate the complex Gaussian distribution based on the combined vector, a simple Gaussian distribution, and a reverse conditional normalizing flow model.

14. The apparatus of claim 13, wherein the reverse conditional normalizing flow model transforms the simple Gaussian distribution to the complex Gaussian distribution based on the combined vector.

15. The apparatus of claim 13, wherein the combined vector indicates one or more conditions for transforming the simple Gaussian distribution to the complex Gaussian distribution.

16. The apparatus of claim 13, wherein the simple Gaussian distribution is randomly generated.

17. The apparatus of claim 13, wherein to generate the component point cloud the processing device is further configured to:
move a set of points from the randomly generated point cloud based on the complex Gaussian distribution, wherein the complex Gaussian distribution indicates one or more points that can be moved from the randomly generated point cloud.

18. The apparatus of claim 11, wherein the set of specifications indicate one or more physical properties of the physical component.

19. The apparatus of claim 11, wherein the set of meshes indicate physical properties of one or more other components that may interact with the physical component.

20. A non-transitory computer readable medium having instruction stored thereon that, when executed by a processing device, cause the processing device to:
generate a complex Gaussian distribution based on a set of specifications for a physical component, a set of images of the physical component, and a set of meshes for the physical component;
obtain a randomly generated point cloud; and
generate a component point cloud based on the complex Gaussian distribution, the randomly generated point cloud, and a diffusion denoising model, wherein the component point cloud represents the physical component.
